(19) United States
(12) Patent Application Publication
(10) Pub. No.: US 2022/0073340 A1
(43) Pub. Date: Mar. 10, 2022

(54) SHOCK REDUCING BUCKLE AND STRAP ASSEMBLIES FOR GIRTHS AND CINCHES

(71) Applicant: William Alvin Larocque, Aldersyde (CA)

(72) Inventor: William Alvin Larocque, Aldersyde (CA)

(21) Appl. No.: 17/467,354

(22) Filed: Sep. 6, 2021

(30) Foreign Application Priority Data
Sep. 10, 2020 (CA) 3092658

(51) Int. Cl. B68C 1/14; A44B 11/24; A44B 11/00

(52) U.S. Cl. CPC B68C 1/147; B68C 2001/142; A44B 11/008; A44B 11/24

(57) ABSTRACT

A shock reducing buckle or strap assembly for girths and cinches includes an elastic portion in parallel with an inelastic portion. In a non-stretched, neutral position, the elastic portion is shorter than the inelastic portion by a predetermined amount. The assembly may be stretched up to the predetermined amount by overcoming the force of the elastic portion. Upon stretching the assembly by the predetermined amount, the inelastic portion comes in to play and prevents further stretching. A cinch or girth attached to a saddle utilizing the assembly holds the saddle snuggly while still allowing a predetermined amount of “give” or flexibility for comfort of the horse, expansion of the horse's chest during breathing, and reducing shock upon roping a steer or calf. The elastic flexibility is limited and has a “hard stop” limit whereupon the inelastic portion prevents any further stretching. The elastic strap is thus prevented from breaking.

### CROSS-REFERENCE TO RELATED APPLICATIONS

This application claims the benefit of priority of Canadian Patent Application No. 3,092,658 filed Sep. 10, 2020, which is incorporated herein by reference.

### BACKGROUND OF THE INVENTION

### (1) Field of the Invention

The invention pertains generally to horse cinches and girths. More specifically, the invention relates to shock reducing buckle assemblies and strap assemblies for securing girths and cinches to a saddle.

### (2) Description of the Related Art

Cinch straps are often made of leather or other similar material. They are placed under the horse's belly, fastened to each side of the saddle, pulled tight and secured by a buckle arrangement. This type of cinch, with no “give” to it, being pulled tight around the horse's body is uncomfortable to the horse and restricts the natural movement of the horse's chest while breathing. Horses having front and rear cinches very tight cannot flex their backs to get into a better stop or slide.

Cinches with elastic sections are known. One example is described in U.S. Pat. No. 3,828,521 entitled “HUMANE ELASTIC CINCH”, hereinafter referred to as the '521 patent. The '521 patent describes an elastic cinch made of two elastic strap sections on the cinch, which will stretch four full inches, thus allowing the horse to breathe naturally and to be more comfortable, while keeping the saddle in a secure position on the horse's back.

However, cinches with elastic sections such as those described in the '521 patent are generally only utilized in English style horseback riding. In western style, elastic cinch straps would be problematic due to allowing tilting and other movement of the saddle in rodeo events such as calf roping and steer roping.

FIG. 1 and FIG. 2 illustrate what would happen if an elastic cinch 10 such as that disclosed in the '521 patent was to be utilized while steer roping. In particular, FIG. 1 shows a simplified side view of a western saddle 12 sitting snug on the horse 14 prior to the steer 16 being roped. For ease of illustration, the rider and unrelated straps of the rider's setup are omitted in this simplified diagram to not obscure the cinch straps 10 and saddle 12 position.

FIG. 2 shows a side view illustrating how the saddle 12 of FIG. 1 will tilt upwards due to the extreme and sudden forces resulting when the steer 16 is roped and goes in a different direction than the horse 14 while being stopped. As illustrated, the elastic portion 18 of the cinch 10, and in particular the rear cinch 10 in this example, has stretched so much that the saddle 12 is pivoted forward, resulting in its front edge 20 being dug right into the shoulder blades of the horse 14. Such movement by the saddle 12 is undesirable and may hurt the horse 14. Furthermore, in an extreme situation, the forces on the cinch 10 may be so great that the elastic portion 18 of the cinch 10 will break and the cinch 10 will fail putting both the horse 14 and rider in grave danger.

For these reasons, English style elastic cinches and girths 10 are not typically utilized for western style riding and especially not in roping events due to the forces that will be experienced by the saddle 12 and cinch straps 10. However, as mentioned above, leather straps that have very little elasticity are uncomfortable to the horse and restrict breathing. Furthermore, in roping events, the lack of any significant “give” in the cinch also means the horse 14 experiences a large shock each time a steer 16 or calf is roped.

### BRIEF SUMMARY OF THE INVENTION

An object of some embodiments is to provide a shock reducing buckle assembly for equine buckles utilized on cinches and girths.

An object of some embodiments is to provide a shock reducing strap assembly for securing equine saddles to horses.

According to an exemplary embodiment of the invention there is disclosed a buckle assembly for girths and cinches that includes an elastic portion in parallel with an inelastic portion. In a non-stretched, neutral position, the elastic portion is shorter than the inelastic portion by a predetermined amount. The cinch may be stretched up to the predetermined amount by overcoming the force of the elastic portion. Upon stretching the cinch by the predetermined amount, the inelastic portion comes in to play and prevents further stretching.

In this way, the cinch holds the saddle snuggly while still allowing a predetermined amount of “give” or flexibility for comfort of the horse, expansion of the horse's chest during breathing, and reducing shock upon roping a steer or calf. However, the elastic flexibility is limited and has a “hard stop” whereupon the inelastic portion prevents any further stretching. In this way, upon an extreme force, there is reduced risk that the cinch will stretch to such an extreme amount that the elastic strap will break or the saddle will pivot forward into the horse's back.

According to an exemplary embodiment of the invention, there is disclosed a shock reducing assembly including an elastic portion formed by a first material having a first elasticity and an inelastic portion formed by a second material having a second elasticity being less elastic than the elastic portion. The elastic portion and the inelastic portion are attached to one another at a point of attachment. The elastic portion and the inelastic portion extend in parallel with each other from the point of attachment toward a holding piece to which the elastic portion and the inelastic portion are respectively secured. In a non-stretched, neutral position, the elastic portion extends a shorter distance from the point of attachment to the holding piece than the inelastic portion extends from the point of attachment to the holding piece, whereby, in the non-stretched neutral position, the elastic portion is shorter than the inelastic portion by a predetermined distance. In a stretched position, the elastic portion is stretched by an external force acting on the holding piece to overcome an elastic force of the elastic portion such that the elastic portion is stretched by a distance up to the predetermined distance, whereupon the inelastic portion extending between the point of attachment and the holding piece prevents further stretching of the elastic portion past the predetermined distance.

According to an exemplary embodiment of the invention, there is disclosed a cinch comprising a shock reducing assembly on each end of the cinch.

According to an exemplary embodiment of the invention, there is disclosed a girth comprising a shock reducing assembly on each end of the girth.

According to an exemplary embodiment of the invention, there is disclosed a saddle having one or more shock reducing assemblies attached thereto for securing a cinch or girth.

According to an exemplary embodiment of the invention, there is disclosed a method of manufacturing a shock reducing assembly. The method includes forming an elastic portion by a first material having a first elasticity, forming an inelastic portion by a second material having a second elasticity being less elastic than the elastic portion, and attaching the elastic portion and the inelastic portion to one another at a point of attachment. The method further includes extending the elastic portion and the inelastic portion in parallel with each other from the point of attachment toward a holding piece to which the elastic portion and the inelastic portion are respectively secured. The method further includes ensuring that in a non-stretched, neutral position, the elastic portion extends a shorter distance from the point of attachment to the holding piece than the inelastic portion extends from the point of attachment to the holding piece, whereby, in the non-stretched neutral position, the elastic portion is shorter than the inelastic portion by a predetermined distance. In a stretched position, the elastic portion can be stretched by an external force acting on the holding piece to overcome an elastic force of the elastic portion such that the elastic portion can be stretched by a distance up to the predetermined distance, whereupon the inelastic portion extending between the point of attachment and the holding piece prevents further stretching of the elastic portion past the predetermined distance.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows a simplified side view of a western saddle sitting snug on the horse prior to the steer being roped.

FIG. 2 shows a side view illustrating how the saddle of FIG. 1 will tilt upwards due to the extreme and sudden forces resulting when the steer is roped and goes in a different direction than the horse while being stopped.

FIG. 3 illustrates a top view of an elastic portion of a first shock reducing buckle assembly according to an exemplary embodiment.

FIG. 4 illustrates a top view of an inelastic portion of the first shock reducing buckle assembly according to an exemplary embodiment.

FIG. 5 illustrates a buckle portion of the first shock reducing buckle assembly according to an exemplary embodiment.

FIG. 6 illustrates a top view of an assembled first shock reducing buckle assembly formed by the parts shown in FIGS. 3 to 5 according to an exemplary embodiment.

FIG. 7 illustrates a cross sectional side view of the first shock reducing buckle assembly in the neutral position taken along the line A-A illustrated in FIG. 6 while the elastic portion is in a neutral, non-stretched position.

FIG. 8 illustrates a cross sectional side view of the first shock reducing buckle assembly taken along the line A-A illustrated in FIG. 6 while the elastic portion is fully stretched in the D direction.

FIG. 9 shows a side view of how a saddle held on the horse utilizing cinches incorporating the buckle assembly of FIGS. 3-8 is prevented from tilting upwards due to the extreme and sudden forces resulting when the steer is roped and goes in a different direction than the horse.

FIG. 10 illustrates a top view of the elastic portion of a second shock reducing buckle assembly according to an exemplary embodiment.

FIG. 11 illustrates a top view of the inelastic portion of the second shock reducing buckle assembly according to an exemplary embodiment.

FIG. 12 illustrates a buckle portion of the second shock reducing buckle assembly according to an exemplary embodiment.

FIG. 13 illustrates a top view of an assembled second shock reducing buckle assembly formed by the parts shown in FIGS. 10 to 12 according to an exemplary embodiment.

FIG. 14 illustrates a cross sectional side view of the second buckle assembly in a neutral, non-stretched position taken along the line B-B illustrated in FIG. 13.

FIG. 15 illustrates a cross sectional side view of the second buckle assembly taken along the line B-B illustrated in FIG. 13 while the elastic portion is being fully stretched in the D direction.

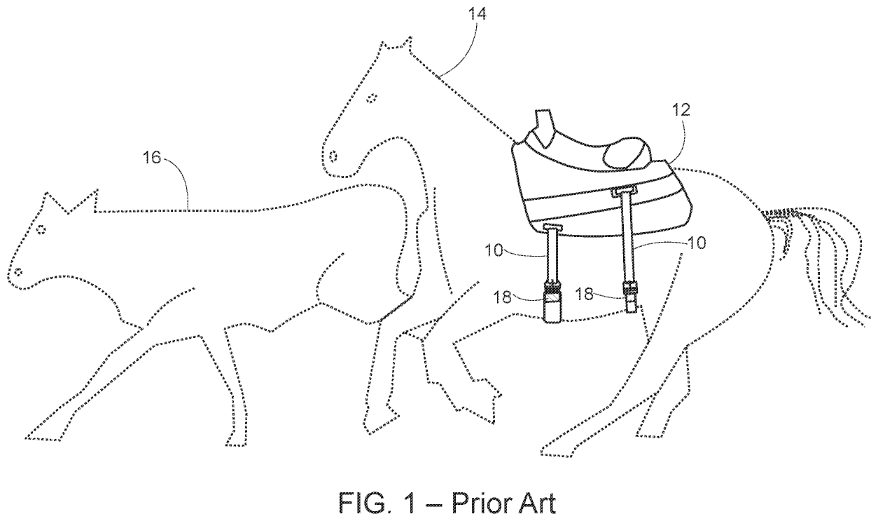

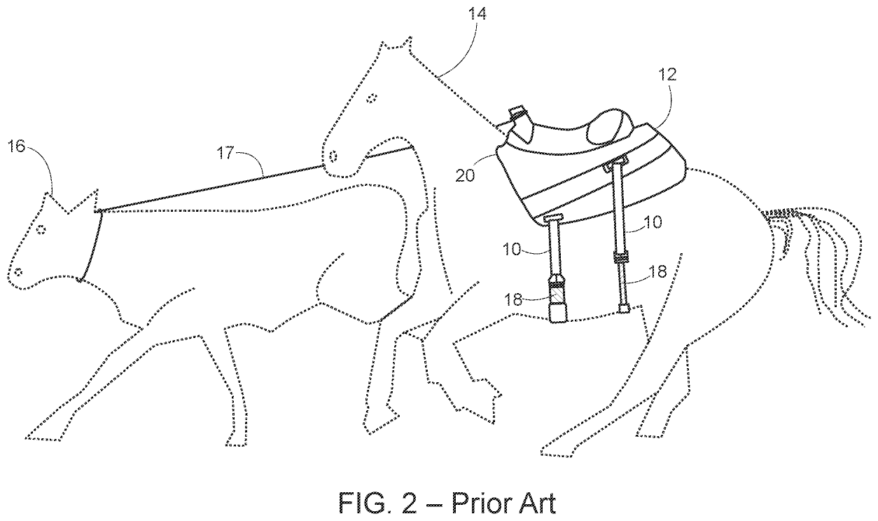

### DETAILED DESCRIPTION

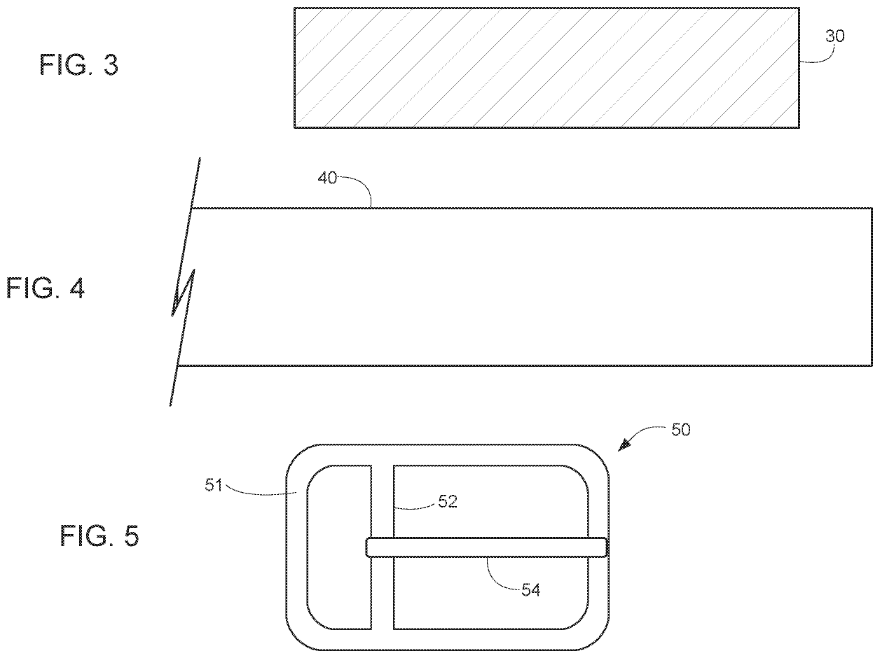

FIGS. 3 to 5 illustrate a plurality of components of a first shock reducing buckle assembly having parallel elastic and inelastic portions according to an exemplary embodiment. In particular,

FIG. 3 illustrates a top view of the elastic portion 30, FIG. 4 illustrates a top view of the inelastic portion 40, and FIG. 5 illustrates a buckle portion 50 of the buckle assembly.

As illustrated in FIG. 3, the elastic portion 30 in this embodiment is formed by a rectangular section of an elastic material such as an elastic strap. The inelastic portion 40 shown in FIG. 4 is a longer strap of inelastic material such as leather, of which only an end portion is shown in FIG. 4. The buckle 50 illustrated in FIG. 5 in this embodiment includes a rectangular metal frame 51, a crossbar 52, and a prong 54 pivotable on the crossbar 52.

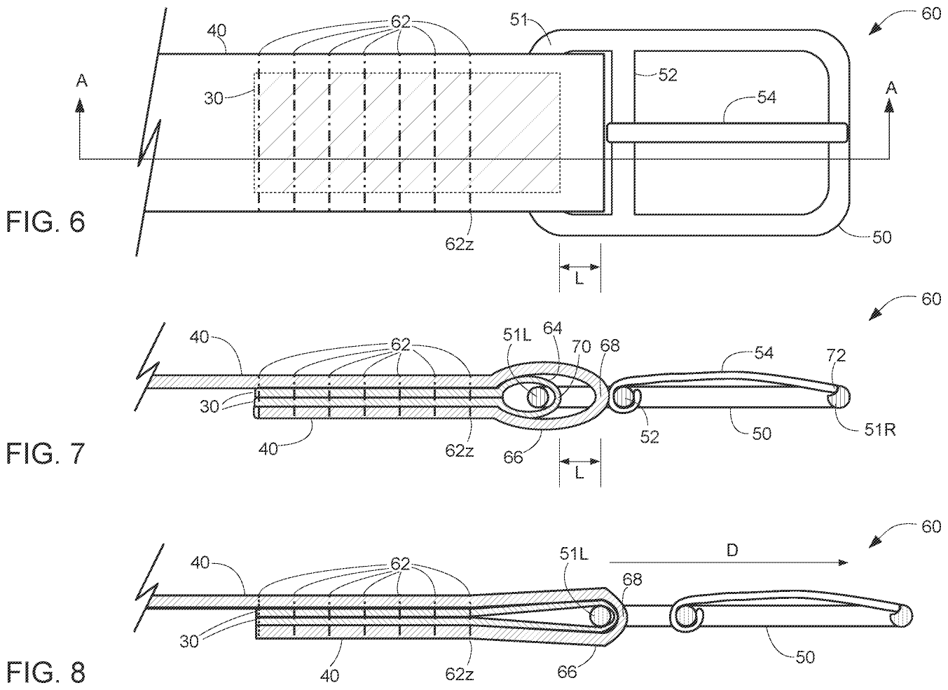

FIG. 6 illustrates a top view of an assembled first shock reducing buckle assembly 60 formed by the parts shown in FIGS. 3 to 5 according to an exemplary embodiment. A similar buckle assemble 60 may be provided on each end of a cinch or girth in some embodiments. For instance, each end of the inelastic portion 40 may include a similar elastic portion 30 and buckle 50.

Both the elastic portion 30 and the inelastic portion 40 are looped around the side of the buckle frame 51 opposite the prong 54. The elastic portion 30 is shown in dotted lines in this diagram because it is sandwiched between the looped inelastic strap 40 and thus would not be directly visible from the top view as it is blocked by the inelastic strap 40 (see FIGS. 7 and 8 for the side cross sectional view illustrating the loops and layers). The loops of the elastic portion 30 and inelastic portions 40 of the buckle assembly 60 are stitched together utilizing a plurality of stitch lines 62. As illustrated, the inelastic portion 40 extends an extra distance L further than the elastic portion 30 as measured from a last of the stitch lines 64z. In some embodiments, the predetermined L distance is substantially half an inch.

FIG. 7 illustrates a cross sectional side view of the buckle assembly 60 in the neutral position taken along the line A-A illustrated in FIG. 6. As shown, the buckle assemble 60 is formed by two loops of material—an inner loop 64 formed by the elastic portion 30 and an outside loop 66 formed by the inelastic portion 40. The forward loop end of the inelastic portion 68 closest to the buckle crossbar 52 is the predetermined distance L ahead of the forward loop end of the elastic portion 70.

In this embodiment, the prong 54 is mounted to the middle crossbar 52 and pivots such that the prong's tip 72 rests on the right-side of the frame 51R. The left side of the frame 51L around which the elastic and inelastic portions 30, 40 loop is therefore independent of the prong 54 and both the elastic and inelastic portions 30, 40 are free to be looped around this side 51L of the frame 51 without worry of interfering with the prong 54. This side 51L of the frame 51 is hereinafter referred to as the holding piece 51L of the frame 51.

FIG. 8 illustrates a cross sectional side view of the buckle assembly 60 taken along the line A-A illustrated in FIG. 6 while the elastic portion 30 is fully stretched in the D direction. When forces in the D direction are experienced on the buckle portion 50, the holding piece 51L of the buckle 50 can pull the elastic portion 30 forward in the D direction. The elastic portion 30 stretches a distance up to the predetermined L distance whereupon it reaches the end 68 of the loop 66 of the inelastic material 40. At this point, the forces from the frame 51L of the buckle 50 are resisted by the inelastic portion 40 of the strap and the buckle holding frame 51L can no longer move forward in the D direction. Beneficially, the strength of the inelastic portion 40 of the strap now both prevents the buckle 50 from moving further in the D direction and also protects the elastic portion 30 from being overstretched past the predetermined L amount.

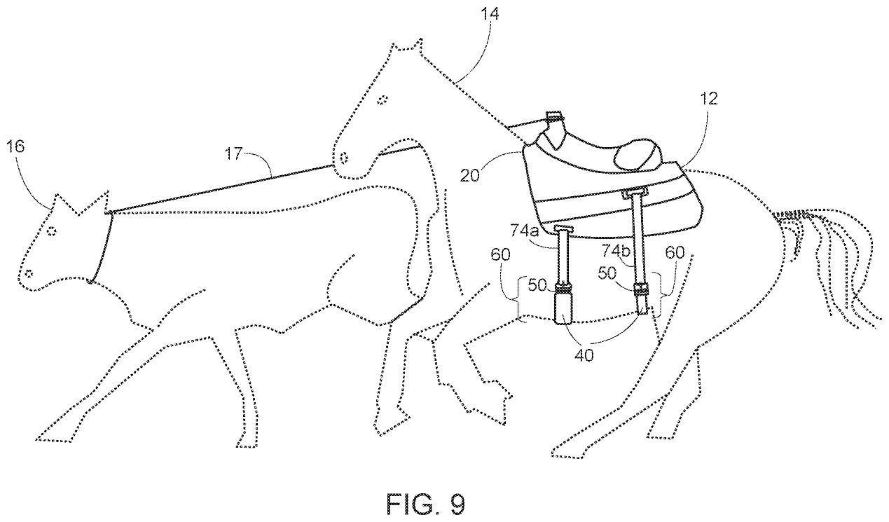

FIG. 9 shows a side view illustrating how a saddle 12 held on the horse 14 utilizing cinches 74a,b incorporating the buckle assembly 60 of FIGS. 3-8 is prevented from tilting upwards due to the extreme and sudden forces resulting when the steer 16 is roped 17 and goes in a different direction than the horse 14.

Beneficially, the cinches 74a,b incorporating the buckle assembly 60 of FIGS. 3-8 do allow some flex to the rear cinch 74b to flex up to the predetermined L distance. However, upon a sudden extreme force in the D direction, the predetermined L distance is quickly reached with a shock reducing effect provided by the elastic portion 30 resisting the stretching, and the cinch 74b will at that point hold a fixed length and expand no further. In this way, the saddle 14 is still held level on the horse's 14 back and does not dig its front edge 20 into the horse's 14 shoulder blades. Likewise, the elastic portion 30 of the cinch 74a,b is protected from the extreme forces attempting to pull it past the L distance and is therefore protected from inadvertently breaking from stretching too far.

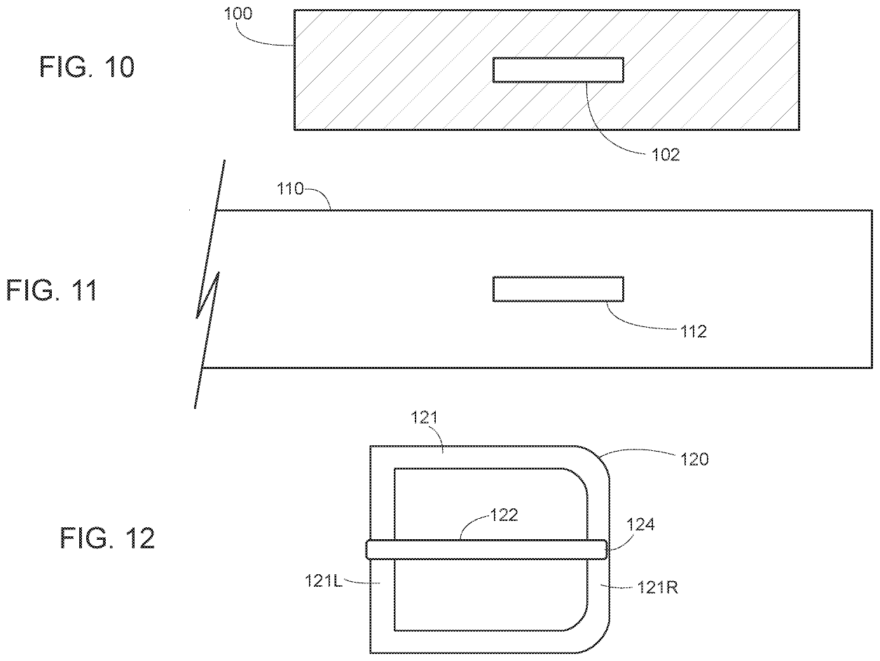

FIGS. 10 to 12 illustrate separate components of a second shock reducing buckle assembly having parallel elastic and inelastic portions 100, 110 according to an exemplary embodiment. In particular, FIG. 10 illustrates a top view of the elastic portion 100 of the buckle assembly, FIG. 11 illustrates a top view of the inelastic portion 110, and FIG. 12 illustrates a buckle portion 120.

Similar to as previously described, the elastic portion 100 in this embodiment is formed by a rectangular section of an elastic material such as an elastic strap. However, in this embodiment, the elastic portion 100 includes a cut-out 102 in a center area. The inelastic portion 110 shown in FIG. 11 is again a longer strap of inelastic material such as leather, and the end portion shown in FIG. 11 includes a cut-out 112 of similar size and shape as the cut-out 102 of the elastic portion 100. The buckle 120 illustrated in FIG. 5 in this embodiment includes a rectangular metal frame 121 where one of the frame's vertical sides 121L acts as the holding piece, and a prong 122 is pivotably mounted on the holding piece 121L with a tip 124 that can meet an opposite side 121R depending on the pivot angle.

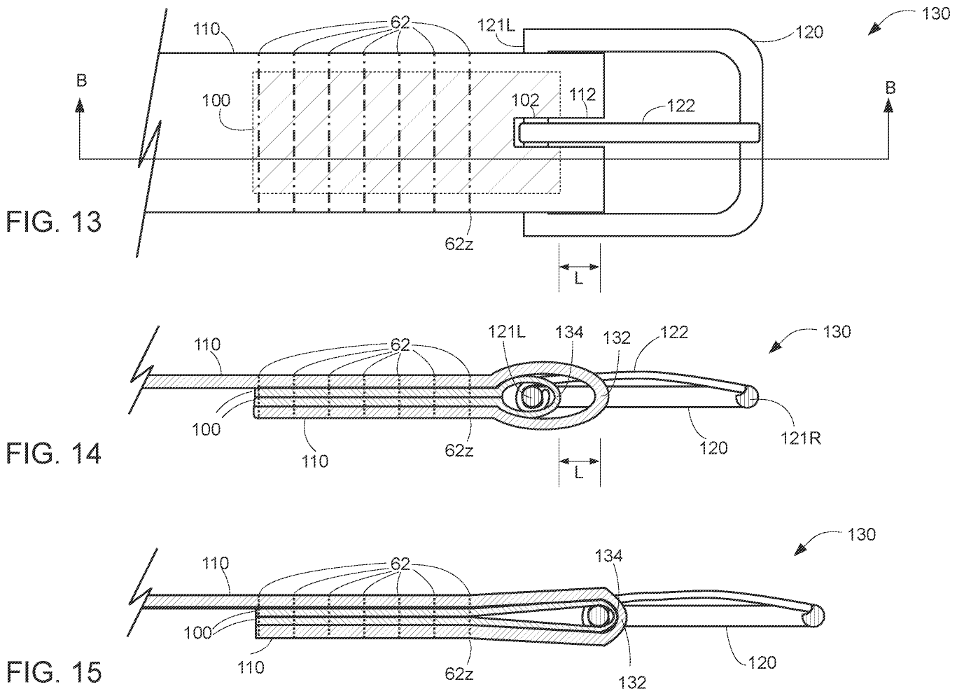

FIG. 13 illustrates a top view of an assembled buckle assembly 130 formed by the parts shown in FIGS. 10 to 12 according to an exemplary embodiment. The structure of the second buckle assemble 130 is very similar to as in the previously described first buckle assembly 60 embodiment where both the elastic portion 100 and the inelastic portion 110 are looped around the left side 121L of the buckle 120 frame 121 (i.e., the side 121L of the frame 121 where the prong 122 is attached, opposite the side 121R of the frame 121 from where the tip 124 of the prong 122 rests). In this embodiment, the prong 122 is pivotably attached to the left side 121L of the frame 121 (i.e., the holding piece 121L) around which the elastic and inelastic portions 100, 110 are looped. The cut-outs 102, 112 allow the prong 122 of the buckle 120 to pass through the elastic and inelastic portions 100, 110 and to be pivoted between an open and closed position as desired by a user.

Again the elastic portion 100 is shown in dotted lines in FIG. 13 because it is sandwiched between the looped inelastic strap 110 and thus would not be directly visible from the top view as it is blocked by the inelastic strap 110 (see FIGS. 14 and 15 for the side cross view illustrating the loops and layers). Also similar to as before, the looped portions of the elastic portion 100 and inelastic portions 110 of the buckle assembly 130 are stitched together with stitch lines 62, and the inelastic portion 110 extends an extra distance L further than the elastic portion 100 as measured from a last of the stitching lines 62z.

FIG. 14 illustrates a cross sectional side view of the second buckle assembly 130 in the neutral position taken along the line B-B illustrated in FIG. 13. As shown, the second buckle assembly 130 is formed by two loops of material—an inner loop formed by the elastic portion 100 and an outside loop formed by the inelastic portion 110. The forward loop end 132 of the inelastic portion closest to the buckle 120 is the predetermined distance L ahead of the forward loop end 134 of the elastic portion 100. In this embodiment, both the elastic and inelastic portions 100, 110 loop around the holding piece 121L of the frame 121 upon which the pivotable prong 122 is mounted. The prong 122 passes through the elastic and inelastic portions 100, 110 via their respective cut-outs 102, 112.

FIG. 15 illustrates a cross sectional side view of the second buckle assembly 130 taken along the line B-B illustrated in FIG. 13 while the elastic portion 100 is being fully stretched in the D direction. Very similar to as in the previous embodiment, when forces in the D direction are experienced on the buckle portion 120, the frame 121L of the buckle 120 can pull the elastic portion 100 forward in the D direction. The elastic portion 100 stretches a distance up to the predetermined L distance whereupon its end 134 reaches the end 132 of the loop of inelastic material 110.

Although the cut-out section 112 does weaken the strength of the inelastic portion 110 of the cinch in comparison to other embodiments that do not have a cut-out 112, the difference in strength in many applications is not a concern and the inelastic portion 110 of the strap is still strong enough even with the cut-out 112 to fully resist the forces attempting to move the buckle 120 forward in the D direction. Again, the strength of the inelastic portion 110 of the strap prevents both the buckle 120 from moving further in the D direction and protects the elastic portion 100 from being overstretched past the predetermined L amount.

A method of manufacturing a shock reducing buckle assembly 60, 130 for equine buckles includes the following steps. The process begins with selecting a desired buckle—for instance, in different embodiments, either a buckle 50 with an independent middle crossbar 52 such as shown in FIG. 5, or a buckle 120 without one such as illustrated in FIG. 12. An elastic portion 30, 100 of strap is attached to the holding piece 51L, 121L of the buckle 50, 120. The holding piece 51L, 121L will generally be either an independent side of the frame 51L such as in buckles 50 that have a separate crossbeam 52 for supporting the buckle prong 54, or may be the side 121L of the frame 121 attached to and supporting the buckle prong 122 itself in different embodiments.

The process continues by attaching an inelastic portion 40, 110 such as a leather strap of a cinch over top of the elastic portion 30, 100 leaving a predetermined distance L of room for the elastic 30, 100 to take some shock before the inelastic portion 40, 110 (i.e., the leather) bottoms out tight on the buckle 50, 120.

In some embodiments, the steps of attaching the elastic 30, 100 and inelastic 40, 110 portions of the strap to the holding piece 51L, 121L of the buckle involves looping the elastic 30, 100 and inelastic 40, 110 portions respectively around the holding piece 51L, 121L with the elastic portion 30, 100 forming a smaller diameter loop within the loop of the inelastic portion 40, 110.

The process then continues by sewing the elastic into the leather such that the elastic 30, 100 and inelastic portions 40, 110 are secured together and overlapping in one or more layers.

In some embodiments, the buckle 50, 120 is sewn in solid with leather 40, 110 as the stopping point when tight. The elastic portion 30, 100 may be a strong piece of elastic that comes tight about half an inch before the leather of the inelastic portion 40, 110 comes into effect. In some embodiments, the design will keep the saddle 12 tight from the elastic portion 30, 100 alone while additionally giving some shock absorption before the leather of the inelastic portion 40, 110 becomes tight.

Exemplary benefits of certain embodiments include improving on the comfort of horses 14 stopping in calf/steer 16 roping or team roping, or any sliding horse events. In roping events, the sudden stopping force in calf roping events of a 400 lbs calf or in steer 16 roping events of a 600 lbs steer going from thirty miles per hour (mph) to zero in approximately ten feet will be sufficient to pull the elastic portion 30, 100 to the end of the predetermined L distance whereupon the inelastic portion 40, 110 prevents any further stretching.

Typical English girths already have elastics 18 such as the '521 patent described in the background section; however, although the elastic 18 is strong, it has no stopping points and theoretically can be stretched until it breaks. In contrast, in embodiments descried herein, two strap portions of different elasticity are run in parallel to one another where the more elastic portion 30, 100 is shorter in distance than the more inelastic portion 40, 100. In this way, during a first phase of a sudden stretching force, the elastic portion 30, 100 can expand up to a predetermined distance L, and then during a second phase, the inelastic portion 40, 100 comes into play and further stretching is prevented.

According to an exemplary embodiment of the invention, a shock reducing buckle or strap assembly 60, 130 for girths and cinches includes an elastic portion 30, 100 in parallel with an inelastic portion 40, 110. In a non-stretched, neutral position, the elastic portion 30, 100 is shorter than the inelastic portion 40, 110 by a predetermined amount. The assembly 60, 130 may be stretched up to the predetermined amount by overcoming the force of the elastic portion 30, 100. Upon stretching the assembly by the predetermined amount, the inelastic portion 40, 110 comes in to play and prevents further stretching. A cinch or girth 74a,b attached to a saddle 12 utilizing the assembly 60, 130 holds the saddle 12 snuggly while still allowing a predetermined amount of “give” or flexibility for comfort of the horse 14, expansion of the horse's 14 chest during breathing, and reducing shock upon roping 17 a steer 16 or calf. The elastic flexibility is limited and has a “hard stop” limit whereupon the inelastic portion 40, 110 prevents any further stretching. The elastic strap 30, 100 is thus prevented from breaking.

Although the invention has been described in connection with preferred embodiments, it should be understood that various modifications, additions and alterations may be made to the invention by one skilled in the art without departing from the spirit and scope of the invention.

For example, the steps of the above-described methods are not restricted to the exact order shown and described, and, in other configurations, described steps may be omitted or other intermediate steps added.

Other techniques of attaching the elastic 30, 100 and inelastic 40, 110 portions to a buckle 50, 120 other than by looping the straps 30, 100, 40, 110 around a holding piece 51L, 121L of the buckle 50, 120 may be utilized in other embodiments. For instance, the straps 30, 100, 40, 110 may attach directly to the holding piece 51L, 121L such as by entering a slot of the holding piece 51L, 121L or being otherwise fastened directly to the frame 51, 121 of the buckle 50, 120.

Although the above description has focused on a buckle assembly 60, 130 for cinches and girths 74a,b, a similar technique may also be utilized on a strap provided elsewhere with or without an integrated buckle 50, 120. For instance, omitting the buckle 50, 120 from the above illustrated embodiments results in shock reducing strap assemblies. In some applications, rather than providing a shock reducing buckle assembly as shown above, a shock reducing strap assembly having the same structure of dual looping sections of strap 30, 100, 40, 110 including an elastic loop 30, 100 of smaller diameter secured within an inelastic loop 40, 110 of larger diameter may be provided instead. In some embodiments, a saddle 12 with multiple shock reducing strap assemblies in this manner is provided, where each strap assembly is for attaching to one end of a conventional inelastic cinch or girth. Similar benefits as described herein are achieved when a conventional inelastic leather cinch or girth is attached to a shock reducing strap assembly that includes the elastic 30, 100 and inelastic 40, 110 loops in the straps coming from the saddle 12.

Different versions of shock reducing buckle assemblies 60, 130 and shock reducing strap assemblies may be produced having different predetermined L distances. For example, although an L distance of half an inch was described above, this was just in an exemplary embodiment. In other embodiments, larger L distances such as three quarters of an inch are utilized. Likewise, in yet other embodiments, smaller L distances such as a quarter of an inch are utilized. In some embodiments, the L distance is preselected during manufacture to be within a range of a quarter of an inch to one inch. In yet other embodiments, the upper range of the L distance may be two inches.

Furthermore, in some embodiments, the predetermined distance L may also be user selectable. In some embodiments, rather than stitching lines 62 securing the elastic portion 30, 100 to the inelastic portion 40, 110, one or more removable pins or rivets may be utilized. In this way, a user may increase or decrease the L distance by removing the pins or rivets in order to shift the elastic portion 30, 100 relative to the inelastic portion 40, 110 to either increase or decrease the predetermined L distance before re-securing the pins or rivets.

The above-described buckle and strap embodiments may be utilized with both western style cinches and English style girths 72a,b. As far as this description is concerned, examples provided herein of cinches may also apply to girths and vice versa.

The dimensions of above-described and/or illustrated assembly 60, 130 components may be changed such as by having wider buckles 50, 120 to help the elastic portion 30, 100 have sufficient strength to resist stretching to provide ample shock reducing effect. Likewise, the widths of the elastic 30, 100 and inelastic 40, 110 portions may be any size appropriate for desired applications.

Materials for either the elastic portion 30, 100 or the inelastic portion 40, 110 may be selected and/or changed in different embodiments. Examples of materials that may be utilized in some embodiments for the elastic portion 30, 100 include strong elastic fabric, bungee cord material, rubber, loop nylon material, wool and other stretchable materials, etc. Examples of materials that may be utilized in some embodiments for the inelastic portion 40, 110 include leather, rope, chain link, fleece, mohair, and neoprene, and other inelastic materials, etc.

Impact gel may also be incorporated into the cinch/girth strap 72a,b in some embodiments to reduce shock and increase comfort to horse.

Functions of single modules may be separated into multiple units, or the functions of multiple modules may be combined into a single unit. For example, although the buckles 50, 120 illustrated above have integral frames 51, 121 that are formed as a solid piece of metal, in other embodiments, the frame 51, 121 may be formed by one or more pieces that are joined together. In some embodiments, a holding piece 51L, 121L of the frame 51, 121 around which the elastic 30, 100 and inelastic 40, 110 portions of the strap are looped may initially be separate from the frame 51, 121 and then installed to the frame 51, 121 of the buckle 50, 120 during manufacture.

All combinations and permutations of the above described features and embodiments may be utilized in conjunction with the invention.

What is claimed is:

1. A shock reducing assembly comprising:
an elastic portion formed by a first material having a first elasticity; and
an inelastic portion formed by a second material having a second elasticity being less elastic than the elastic portion;
wherein the elastic portion and the inelastic portion are attached to one another at a point of attachment;
the elastic portion and the inelastic portion extend in parallel with each other from the point of attachment toward a holding piece to which the elastic portion and the inelastic portion are respectively secured;
in a non-stretched, neutral position, the elastic portion extends a shorter distance from the point of attachment to the holding piece than the inelastic portion extends from the point of attachment to the holding piece, whereby, in the non-stretched neutral position, the elastic portion is shorter than the inelastic portion by a predetermined distance; and
in a stretched position, the elastic portion is stretched by an external force acting on the holding piece to overcome an elastic force of the elastic portion such that the elastic portion is stretched by a distance up to the predetermined distance, whereupon the inelastic portion extending between the point of attachment and the holding piece prevents further stretching of the elastic portion past the predetermined distance.

2. The shock reducing assembly of claim 1, wherein the elastic portion and the inelastic portion are attached to one another at the point of attachment being a stitch line.

3. The shock reducing assembly of claim 1, wherein:
the elastic portion is secured to the holding piece by a first loop around the holding piece; and
the inelastic portion is secured to the holding piece by a second loop around the holding piece.

4. The shock reducing assembly of claim 1, wherein:
the elastic portion extends from the point of attachment in an inner loop that loops around the holding piece and returns to the point of attachment; and
the inelastic portion extends from the point of attachment in an outside loop that loops around the holding piece on an opposite side of the elastic portion than the holding piece such that the elastic portion is sandwiched within the outside loop of the inelastic portion.

5. The shock reducing assembly of claim 4, wherein, in the non-stretched, neutral position, a forward loop end of the inner loop of the elastic portion around the holding piece extends from the point of attachment the predetermined distance shorter than a forward loop end of the outside loop around the holding piece extends from the point of attachment.

6. The shock reducing assembly of claim 1, further comprising:
a buckle having a rectangular frame, a middle crossbar, and a prong pivotable on the middle crossbar;
wherein the holding piece is a side of the rectangular frame of the buckle.

7. The shock reducing assembly of claim 1, further comprising:
a buckle having a rectangular frame and a prong pivotable on a first side of the rectangular frame;
wherein the holding piece is the first side of the rectangular frame of the buckle.

8. The shock reducing assembly of claim 7, further comprising:
a first cut-out in the elastic portion; and
a second cut-out in the inelastic portion;
wherein, the elastic portion and the inelastic portion are secured to the first side of rectangular frame by looping around the first side of the rectangular frame; and
the prong of the buckle extends through the first cut-out and the second cut-out.

9. The shock reducing assembly of claim 1, wherein the first material forming the elastic portion is selected from the group comprising elastic fabric, bungee cord, rubber, loop nylon, and wool.

10. The shock reducing assembly of claim 1, wherein the second material forming the inelastic portion is selected from the group comprising leather, rope, chain link, fleece, mohair, and neoprene.

11. The shock reducing assembly of claim 1, wherein the predetermined distance is half an inch.

12. The shock reducing assembly of claim 1, wherein the predetermined distance is within a range of a quarter of an inch to one inch.

13. The shock reducing assembly of claim 1, wherein:
the elastic portion is attached to the inelastic portion by one or more user-removable pins or rivets; and
the predetermined distance is user selectable by removing the pins or rivets in order to shift the elastic portion relative to the inelastic portion to either increase or decrease the predetermined distance before re-securing the pins or rivets.

14. The shock reducing assembly of claim 1, further comprising impact gel incorporated into a strap to which the shock reducing assembly is attached.

15. A cinch comprising a shock reducing assembly of claim 1 on each end of the cinch.

16. A girth comprising a shock reducing assembly of claim 1 on each end of the girth.

17. A saddle having one or more shock reducing assemblies of claim 1 attached thereto for securing a cinch or girth.

18. A method of manufacturing a shock reducing assembly, the method comprising:
forming an elastic portion by a first material having a first elasticity;
forming an inelastic portion by a second material having a second elasticity being less elastic than the elastic portion;
attaching the elastic portion and the inelastic portion to one another at a point of attachment;
extending the elastic portion and the inelastic portion in parallel with each other from the point of attachment toward a holding piece to which the elastic portion and the inelastic portion are respectively secured; and
ensuring that in a non-stretched, neutral position, the elastic portion extends a shorter distance from the point of attachment to the holding piece than the inelastic portion extends from the point of attachment to the holding piece, whereby, in the non-stretched neutral position, the elastic portion is shorter than the inelastic portion by a predetermined distance;
whereby, in a stretched position, the elastic portion can be stretched by an external force acting on the holding piece to overcome an elastic force of the elastic portion such that the elastic portion can be stretched by a distance up to the predetermined distance, whereupon the inelastic portion extending between the point of attachment and the holding piece prevents further stretching of the elastic portion past the predetermined distance.

19. The method of claim 18, further comprising:
extending the elastic portion from the point of attachment in an inner loop that loops around the holding piece and returns to the point of attachment; and
extending the inelastic portion from the point of attachment in an outside loop that loops around the holding piece on an opposite side of the elastic portion than the holding piece such that the elastic portion is sandwiched within the outside loop of the inelastic portion.

20. The method of claim 19, further comprising ensuring that, in the non-stretched, neutral position, a forward loop end of the inner loop of the elastic portion around the holding piece extends from the point of attachment the predetermined distance shorter than a forward loop end of the outside loop around the holding piece extends from the point of attachment.
